(19) United States
(12) Patent Application Publication
(10) Pub. No.: US 2005/0285988 A1
(43) Pub. Date: Dec. 29, 2005

(54) Electro-optical device, electronic apparatus, and method of manufacturing the electro-optical device

(75) Inventor: Masashi Nakagawa, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/148,299

(22) Filed: Jun. 9, 2005

(30) Foreign Application Priority Data
Jun. 23, 2004 (JP) 2004-185256

(51) Int. Cl. G02F 1/136

(52) U.S. Cl. 349/44

(57) ABSTRACT

An electro-optical device includes a substrate; thin film transistors provided on the substrate and including a semiconductor layer having a channel region thereon; display electrodes provided on the substrate and electrically connected to the thin film transistors; storage capacitors electrically connected to the display electrodes; an interlayer insulating layer deposited on at least one side of an upper layer side and a lower layer side of the semiconductor layer; and a light shielding layer deposited on a side of the interlayer insulating layer not facing the semiconductor layer to shield the channel region from light, in which concave portions locally pitted toward the semiconductor layer are formed on a surface of the interlayer insulating layer not facing the semiconductor layer, in a region where at least edge of the channel region out of the channel region can be shielded from light, and in which the light shielding layer is formed at least in the concave portion to act as a capacitor electrode of at least one side of each of the storage capacitors.

### BACKGROUND OF THE INVENTION

1. Technical Field

The present invention relates to an electro-optical device such as a liquid crystal device, to an electronic apparatus such as a liquid crystal projector having the electro-optical device, and to a method of manufacturing the electro-optical device.

2. Related Art

In such electro-optical devices, an active matrix driving method is widely employed, in which thin film transistors (hereinafter, referred to as TFTs) are used as pixel selection switching elements. When incident light is irradiated onto a channel region of the TFT, an optical leakage current is generated due to excitation by light, which deteriorates the characteristics of the TFT to cause, for example, nonuniformity of image quality, degradation of contrast ratio, and degradation due to flickering. Although the TFTs are typically arranged in a region other than the opening of the pixel, light still reaches the TFTs. This is because not all components of the incident light are perpendicular to the substrate. The incident light may be diffuse-reflected or multiple-reflected at wiring lines to be irradiated onto the TFTs. Since the intensity of incident light is large in recent electro-optical devices, it is important to suppress light incident on the TFTs.

For this reason, a structure is employed in which a light shielding layer is provided on an interlayer insulating layer deposited at an upper layer side of the TFT, or below an interlayer insulating layer serving as a base layer of the TFT, thereby shielding the channel region or a peripheral region thereof from light. However, in order to effectively shield the channel region of the TFT from multiple reflection inside a device, the light shielding layer should be arranged as close as possible to the channel. Japanese Unexamined Patent Application Publication No. 2003-140566 discloses a structure in which a groove is formed on an interlayer insulating layer on a gate such that the groove reaches an etching stopper layer covering the gate, and a light shielding layer is formed in the groove, thereby narrowing the distance between the light shielding layer and the channel region.

However, in Japanese Unexamined Patent Application Publication No. 2003-140566, since a stacked structure is complex, a step on the TFT array substrate surface increases, and as a result, it is possible that residual etching occurs in a patterning process of the upper layer, which reduces the production yield or affects alignment of an electro-optical material, such as liquid crystal. To reduce the distance between the light shielding layer and the channel region, the interlayer insulating layer may be formed thinner. However, in this case, the step on the TFT array substrate surface increases by the amount of this thinning, which leads to the above-mentioned problem. Further, there is a concerning that the distance between wiring lines will be reduced, generating parasitic capacitance, or cracks will easily occur. In other words, with the above-mentioned structure, there is a technical problem in which other difficulties occur in exchange for a sufficient light shielding efficiency.

### SUMMARY

An advantage of the invention is that it provides an electro-optical device, an electronic apparatus including the electro-optical device, and a method of manufacturing the electro-optical device, all of which can prevent an optical leakage current from being generated without inducing other problems, thereby enabling high quality display.

According to a first aspect of the invention, an electro-optical device includes a substrate; thin film transistors provided on the substrate and including a semiconductor layer having a channel region thereon; display electrodes provided on the substrate and electrically connected to the thin film transistors; storage capacitors electrically connected to the display electrodes; an interlayer insulating layer deposited on at least one of an upper layer side and a lower layer side of the semiconductor layer; and a light shielding layer deposited on a surface of the interlayer insulating layer not facing the semiconductor layer to shield the channel region from light. Here, concave portions locally pitted toward the semiconductor layer are formed on a surface of the interlayer insulating layer not facing the semiconductor layer, in a portion of the channel region where can shield at least the edge of the channel region from light, and the light shielding layer is formed at least in the concave portion to act as a capacitor electrode of at least one side of each of the storage capacitors.

In the above-mentioned electro-optical device according to the first aspect of the invention, the thin film transistors are provided to drive the display electrodes, and the concave portions are formed at least one of the surfaces of the interlayer insulating layer stacked on the upper side of the semiconductor layer, and the surface below the interlayer insulating layer stacked on the lower side of the semiconductor layer. In other words, the stack is configured in an order of ‘the semiconductor layer→the interlayer insulating layer (where the concave portion pitted toward the lower layer is formed)→the light shielding layer’ or ‘the light shielding layer→the interlayer insulating layer (where the concave portion pitted toward the upper layer is formed)→the semiconductor layer’ from the lower layer. The concave portion, which refers to a portion locally pitted toward the semiconductor layer on the surface of the interlayer insulating layer, is locally formed in a region corresponding to the channel region, at least in a region where edge of the channel region can be shielded from light. As a result, the interlayer insulating layer becomes locally thinner in a region where the concave portion is formed.

Further, the light shielding layer is formed in the concave portions. In other words, the light shielding layer shields at least the edge of the channel region through the concave portions. Here, the reason why a region to be shielded is ‘at least the edge of the channel region’ is that, for example, when a gate is formed directly on the channel region, light typically penetrates into the channel region from the periphery, so that the peripheral portion is more important than the surface in terms of the light shielding. The light shielding layer is closer to at least the edge of the channel region as much as the interlayer insulating layer is thinner, thereby improving the light shielding effect. In addition, the interlayer insulating layer is locally thin, but the entire layer is not thin, so that it is possible to address problems such as the step, the parasitic capacitance between wiring lines interposed with the interlayer insulating layer, and the crack.

Furthermore, when the light shielding layer is formed on the upper layer side of the semiconductor layer, it can shield a channel region from an inclined incident light or a reflection light incident from the upper layer side, and when the light shielding layer is formed on the lower layer side of the semiconductor layer, it can shield a channel region from the reflection light. Here, the ‘reflection light’ includes light that, when a plurality of electro-optical devices are combined as a light bulb to form a multiple plate type projector, penetrates a combined optical system such as a prism from another light bulb. It refers to entire light attempting to infiltrate into the TFT channel region from the substrate side (i.e., downward). In addition, it is desirable that the ‘interlayer insulating layer’ where the concave portion is formed and ‘light shielding layer’ formed in the concave portion be arranged as close as possible to the semiconductor layer, for the purpose of light shielding the channel region as close as possible, but other layers may be interposed between the light shielding layer and the interlayer insulating layer, or between the interlayer insulating layer and the semiconductor layer. Even in this case, the distance between the light shielding layer and the channel region is reduced using the concave region, so that the effects and advantages of the invention can be sufficiently achieved.

However, when the concave portion is too deep, there occurs a problem in that a parasitic capacitance between the interlayer insulating layer and the upper and lower wiring lines is necessarily generated, or in that the light shielding layer is connected to the semiconductor layer through the interlayer insulating layer. Here, it is highly desirable that the concave portions be formed using a method in that the dimension or shape can be easily controlled, for example, using etching. Here, for example, in a method of polishing to remove a portion (e.g., for an LDD (light doped drain), the channel region is bulged as much as the gate is stacked) corresponding to the channel region of the interlayer insulating layer surface through a chemical mechanical polishing (CMP), a dimensional error in a depth direction is about 200 nm, and accordingly, crack may be generated during a mechanical processing. A method of forming an interlayer insulating layer, of which an upper surface is flat, using a spin on glass (SOG) can also be available, however, it is not confirmed that a process of annealing the SOG does not affect characteristics of the TFT.

As such, when at least a part of the light shielding layer, which shields the channel region of the thin film transistor from light, is formed in the concave portion of the interlayer insulating layer, the light shielding layer can be close to the channel region just as much as the interlayer insulating layer becomes thinner due to the concave portion, so that light incident on the channel region can be efficiently shielded. Therefore, generation of the optical leakage current in the thin film transistor can be prevented or suppressed, so that it is possible to favorably prevent those caused by the optical leakage current, such as nonuniform image quality, decrease of a contrast ratio, and degradation of flickering characteristics.

In addition, since there is little substantial effect of the concave portions on other elements in terms of configuration and manufacturing process, the electro-optical device of the invention has little problem, other than the optical leakage current, caused by the above arrangement. Further, the interlayer insulating layer itself is not thinner even when the concave portions are formed, so that various problems caused by the thin interlayer insulating layer can be avoided. Furthermore, since the concave portions can be simply fabricated through etching or the like, there is little or no problem in terms of configuration and production efficiency.

Further, according to a second aspect of the invention, an electro-optical device includes a substrate; thin film transistors provided on the substrate and including a semiconductor layer having a channel region thereon; display electrodes provided on the substrate and electrically connected to the thin film transistor; storage capacitors electrically connected to the display electrodes; an interlayer insulating layer deposited on at least one side of an upper layer side and a lower layer side of the semiconductor layer; and a light shielding layer deposited on a side of the interlayer insulating layer not facing the semiconductor layer side to shield the channel region from light. Here, concave portions locally pitted toward the light shielding layer are formed on a surface of the interlayer insulating layer facing the semiconductor layer, in at least a portion of a region opposite to the channel region, and the light shielding layer also acts as a capacitor electrode of at least one side of each of the storage capacitors.

In the electro-optical device according to the second aspect of the invention, since the concave portions are formed in a surface of the interlayer insulating layer which faces the semiconductor layer of the thin film transistors, at least a part of the semiconductor layer is formed in the concave portion of the interlayer insulating layer. In other words, while the light shielding layer is formed in the concave portion according to the electro-optical device of the first aspect of the invention, the semiconductor layer is formed in the concave portions according to the electro-optical device of the second aspect of the invention, so that a positional relationship between the semiconductor layer and the light shielding layer is exchanged with respect to the first electro-optical device. Here, the stack is configured in an order of ‘the light shielding layer→the interlayer insulating layer (where the concave portion pitted toward the lower layer is formed)→the semiconductor layer’ or ‘the semiconductor layer→the interlayer insulating layer (where the concave portion pitted toward the upper layer is formed)→the light shielding layer’ from the lower layer. Therefore, the effect and advantages are the same as those in the above-mentioned electro-optical device according to the first aspect of the invention.

In the electro-optical device according to the first aspect of the invention, it is preferable that the interlayer insulating layer be provided directly on the thin film transistors on the substrate, and the light shielding layer be formed directly on the concave portion.

According to the above-mentioned configuration, the interlayer insulating layer is formed directly on the semiconductor layer to cover it and the light shielding layer is formed directly on the interlayer insulating layer. For this reason, with only one layer of the interlayer insulating layer interposed between the light shielding layer and the channel region, the light shielding layer can be as close as possible to the channel region, so that it is possible to achieve high light shielding effect.

In the electro-optical device according to the first aspect of the invention, it is preferable that the interlayer insulating layer be provided directly below the thin film transistors on the substrate, and the light shielding layer be formed directly below the concave portions.

According to the above-mentioned configuration, the interlayer insulating layer is formed directly below the semiconductor layer, and the light shielding layer is formed directly below the interlayer insulating layer. For this reason, with only one layer of the interlayer insulating layer interposed between the light shielding layer and the channel region, the light shielding layer can be as close as possible to the channel region, so that it is possible to achieve high light shielding effect.

In the electro-optical device according to the first aspect of the invention, it is preferable that the concave portions be formed in a groove shape along a region corresponding to the edge of the channel region.

According to the above-mentioned configuration, the light shielding layer has a configuration in which the light shielding is focused on the edge of the channel region. The optical leakage current is generated from light incident from the periphery of the channel region, and accordingly, in terms of principle, it is important to shield the periphery of the channel region from light. In other words, the concave portion is provided only on the minimal region to be shielded from light, so that it is possible to perform efficient light shielding.

In the electro-optical device according to the first aspect of the invention, it is preferable that, for the concave portion, a plurality of concave portions be successively formed so that a cross section thereof has a ripple shape.

According to the above-mentioned configuration, the plurality of concave portions which is a line of grooves are successively arranged to form an uneven surface. Alternatively, for example, a plurality of concave portions pitted in a dotted manner are successively arranged to form an uneven surface. As a result, the predetermined region is thinner than the remaining regions on the average. With this configuration, depending on the pitch between the concave portions, a step caused by the concave portion that can be located on further upper layer side can be reduced. Here, when some of the concave portions are arranged corresponding to the edge of the channel region, preferably, the light shielding layer shields exactly the edge of the channel region.

In the electro-optical device according to the first aspect of the invention, it is preferable that the concave portions be formed over the entire region corresponding to the channel region.

According to the above-mentioned configuration, the concave portion is formed not only on the edge of the channel region but also over the entire surface thereof. For this reason, it is possible to reliably shield the channel region from light.

In the electro-optical device according to the first aspect of the invention, it is preferable that the light shielding layer also act as storage capacitors for driving the display electrodes.

According to the above-mentioned configuration, since the light shielding layer also acts as an electrode of each of the storage capacitor, the stacked structure on the substrate can be simplified. In each of the storage capacitors, for example, two electrodes are arranged opposite to each other with a dielectric layer interposed therebetween, and one electrode thereof is electrically connected to the display electrode and the other electrode is connected to a static potential wiring line to prevent a current leak from the display electrode.

Here, the storage capacitor also used as the light shielding layer is formed in the concave portion, so that the surface area can be increased. Therefore, with the same or less formation region in a plan view, the surface area of the storage capacitor can be enlarged, and accordingly, the capacitance can be increased. Further, in order to enlarge the surface area, it is effective that a plurality of concave members be successively formed to have a ripple cross section.

In the electro-optical device according to the first aspect of the invention, it is preferable that each of the storage capacitors include a first electrode electrically connected to the display electrode and a second electrode arranged opposite to the first electrode and having a fixed potential, and the second electrode be arranged at a side closer to the semiconductor layer than the first electrode.

In this case, of two electrodes constituting the storage capacitor, the second electrode acting as the fixed potential is arranged closer to the concave portion. Therefore, for the concave portion, even in a situation where the interlayer insulating layer is thin so that the potential of the thin film transistor affects the storage capacitor, since the first electrode easily affected by the potential of the thin film transistor is arranged far therefrom and thus an adverse effect such as the parasitic capacitance can be suppressed. Further, in this case, a shield effect can be expected in the second electrode of the fixed potential side, so that the adverse effect of the display electrode on the first electrode can be suppressed.

According to a third aspect of the invention, an electronic apparatus includes the above-mentioned electro-optical device (including its various aspects).

In the electronic apparatus according to the third aspect of the invention, since the above-mentioned electro-optical device of the invention is included, various electronic apparatuses, which can suppress generation of an optical leakage current without inducing other problems, can be realized, which enables high quality display.

Further, according to a fourth aspect of the invention, a method of manufacturing an electro-optical device, which includes a substrate; thin film transistors provided on the substrate and including a semiconductor layer having a channel region thereon; display electrodes provided on the substrate and electrically connected to the thin film transistor; storage capacitors electrically connected to the display electrode; an interlayer insulating layer deposited on at least one side of an upper layer side and a lower layer side of the semiconductor layer; and a light shielding layer deposited on a side of the interlayer insulating layer not facing the semiconductor layer side to shield the channel region from light, includes: forming the semiconductor layer on the substrate; forming the interlayer insulating layer, acting as a base of the light shielding layer, at one side on the substrate; after forming the interlayer insulating layer, forming unevenness in a region, on a surface of the interlayer insulating layer acting as the base, corresponding to the channel region through etching so that the light shielding layer can be locally adjacent to the semiconductor layer; and after forming the unevenness, forming the light shielding layer in a region where the unevenness is formed, at least on the surface of the interlayer insulating layer acting as the base layer. The light shielding layer also acts as a capacitor electrode of at least one side of the storage capacitor.

In the method of manufacturing the electro-optical device according to the fourth aspect of the invention, the concave portions of the first electro-optical device of the invention are formed through etching. As described above, using the etching method, a shape (in particular, depth) is easily controlled, and the concave portions can be formed simply and accurately in the predetermined shape. Further, in forming the interlayer insulating layer after forming the semiconductor layer, the light shielding layer having a convex or concave shape may be formed on the upper layer side of the semiconductor layer on the substrate. Alternatively, in forming the interlayer insulating layer before forming the semiconductor layer, the light shielding layer having a convex or concave shape may be formed. Therefore, the concave portions can be locally formed on the interlayer insulating layer, and the problem generated when the overall interlayer insulating layer is formed thin can be avoided. In addition, problems, occurred in a manufacturing process, in that the parasitic capacitance of upper and lower wirings of the interlayer insulating layer is necessarily generated due to a very deep concave portion, and the light shielding layer is electrically connected to the semiconductor layer through the interlayer insulating layer can be solved.

Furthermore, according to a fifth aspect of the invention, a method of manufacturing an electro-optical device, which includes a substrate; thin film transistors provided on the substrate and including a semiconductor layer having a channel region thereon; display electrodes provided on the substrate and electrically connected to the thin film transistor; storage capacitors electrically connected to the display electrode; an interlayer insulating layer deposited on at least one side of an upper layer side and a lower layer side of the semiconductor layer; and a light shielding layer deposited on a side of the interlayer insulating layer not facing the semiconductor layer side to shield the channel region from light, includes: forming the light shielding layer on the substrate; forming the interlayer insulating layer, acting as a base of the semiconductor layer, at one side on the substrate; after forming the interlayer insulating layer, forming unevenness in a region, on a surface of the interlayer insulating layer acting as the base, corresponding to the channel region through etching so that the semiconductor layer can be locally adjacent to the light shielding layer; and after forming the unevenness, forming the semiconductor layer in a region where the unevenness is formed, at least on the surface of the interlayer insulating layer acting as the base layer. The light shielding layer also acts as a capacitor electrode of at least one side of each of the storage capacitors.

In the method of manufacturing the electro-optical device according to the fifth aspect of the invention, the concave portions of the second electro-optical device of the invention are formed through etching. Therefore, effect and advantages are the same as those in the method of manufacturing the electro-optical device according to the fourth aspect of the invention. Further, in forming the interlayer insulating layer after forming the light shielding layer, the semiconductor layer having a convex or concave shape may be formed on the upper layer side of the light shielding layer on the substrate. Alternatively, in forming the interlayer insulating layer before forming the light shielding layer, the semiconductor layer having a convex or concave shape may be formed on the lower layer side of the light shielding layer.

The above-mentioned effects and advantages of the invention will now be apparent in the following embodiments.

### BRIEF DESCRIPTION OF THE DRAWINGS

The invention will be described with reference to the accompanying drawings, wherein like numbers reference like elements, and wherein:

FIG. 1 is a plan view showing an overall configuration of a liquid crystal device according to an embodiment of the invention;

FIG. 2 is a cross-sectional view taken along the line I-I′ of FIG. 1;

FIG. 3 is an equivalent circuit diagram showing a configuration of a pixel display region for a liquid crystal device according to an embodiment of the invention;

FIG. 4 is a partial plan view showing a pixel group of the liquid crystal device, in which only a configuration related to portions of lower layers (portions of the lower layers up to reference number 70 (storage capacitor) in FIG. 6) on a TFT array substrate is shown;

FIG. 5 is a partial plan view showing a pixel group of the liquid crystal device, in which only a configuration related to portions of upper layers (portions of the upper layer up to reference number 70 (storage capacitor) in FIG. 6) on a TFT array substrate is shown;

FIG. 6 is a cross-sectional view taken along the line II-II′ when FIGS. 4 and 5 overlap;

FIG. 7A is a plan view showing a configuration of a TFT and the upper layer thereof according to a first embodiment of the invention;

FIG. 7B is a cross-sectional view taken along the line III-III′ line of FIG. 7A;

FIG. 8A is a cross-sectional view showing a process of manufacturing a liquid crystal device according to the first embodiment of the invention;

FIG. 8B is a cross-sectional view showing a process of manufacturing a liquid crystal device according to the first embodiment of the invention;

FIG. 8C is a cross-sectional view showing a process of manufacturing a liquid crystal device according to the first embodiment of the invention;

FIG. 9A is a cross-sectional view of a modified example with respect to the shape of the concave portion of the liquid crystal device according to the first embodiment of the invention;

FIG. 9B is a cross-sectional view of a modified example with respect to the shape of the concave portion of the liquid crystal device according to the first embodiment of the invention;

FIG. 10A is a plan view showing a modified example with respect to the shape of the concave portion of the liquid crystal device according to the first embodiment of the invention;

FIG. 10B is a cross-sectional view taken along the line IV-IV′ of FIG. 10A;

FIG. 11A is a plan view showing a modified example with respect to the shape of the concave portion of the liquid crystal device according to the first embodiment of the invention;

FIG. 11B is a cross-sectional view taken along the line V-V′ of FIG. 11A;

FIG. 12 is a cross-sectional view showing a modified example with respect to a stacked structure of the liquid crystal device according to the first embodiment of the invention;

FIG. 13 is a cross-sectional view showing a modified example with respect to a stacked structure of the liquid crystal device according to the first embodiment of the invention;

FIG. 14 is a cross-sectional view showing a modified example with respect to a stacked structure of the liquid crystal device according to the first embodiment of the invention;

FIG. 15 is a partial plan view showing a configuration of a liquid crystal device according to a second embodiment of the invention;

FIG. 16 is a cross-sectional view taken along the line VI-VI of FIG. 15; and

FIG. 17 is a cross-sectional view showing a configuration of a liquid crystal projector according to an embodiment of the electronic apparatus of the invention.

### DESCRIPTION OF THE EMBODIMENTS

The preferred embodiments of the invention will now be described with reference to the drawings. Further, in the following embodiments, an electro-optical device of the invention is applied to a liquid crystal device.

1: First Embodiment

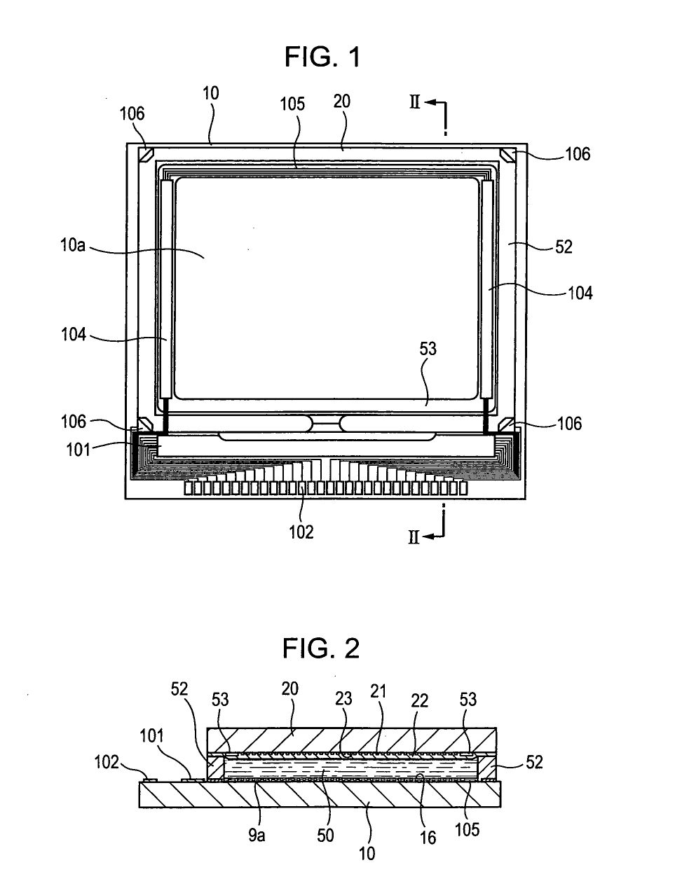

A first embodiment of an electro-optical device of the invention will be described with reference to FIGS. 1 to 8.

1-1: Overall Configuration of Electro-Optical Device

First, the overall configuration of a liquid crystal device according to the present embodiment will be described with reference to FIGS. 1 and 2. Here, FIG. 1 is a plan view showing the overall configuration of a liquid crystal device according to the embodiment, and FIG. 2 is a cross-sectional view taken along the line I-I′ of FIG. 1.

In FIG. 1, a liquid crystal device is configured such that a liquid crystal layer 50 is interposed between a TFT array substrate 10 and a counter substrate 20. In other words, as a specific example of the invention, a TFT active matrix driving scheme installed with a driving circuit is employed in the liquid crystal device. An image display region 10a where images are displayed is specified by a frame-shaped light shielding layer 53, and the TFT array substrate 10 and the counter substrate 20 are attached to each other around the periphery of the image display region 10a through a sealant 52. In the peripheral region located around the image display region 10a, a data line driving circuit 101, and two scanning line driving circuits interconnected by a wiring line 105 are arranged. Further, in the peripheral region, a plurality of external connection terminals 102 are formed in one side of the TFT array substrate 10.

In addition, in four corner portions of the counter substrate 20, upper and lower conductive members 106 serving as upper and lower terminals between the two substrates are arranged, respectively. Further, on the TFT array substrate 10, the upper and lower conducting terminals are arranged in a region facing these corner portions, respectively. Thereby, electrical conduction between the TFT array substrate 10 and the counter substrate 20 can be achieved.

In FIG. 2, for a side of the TFT array substrate 10, pixel electrodes 9a are provided in an upper layer of pixel switching TFTs or wiring lines such as scanning lines and data lines. In addition, an alignment layer 16 is formed directly on the pixel electrode 9a. Further, counter electrodes 21 are formed on the counter substrate 20 with a stripe-type light shielding layer 23 therebetween. Also, an alignment layer 22 is formed on the counter electrode 21. Liquid crystals are injected into a space where the periphery of the TFT array substrate 10 and the counter substrate 20 is sealed with a sealant 52, forming a liquid crystal layer 50. Alignment of the liquid crystals in the liquid crystal layer varies according to an electric field applied between the pixel electrode 9a and the counter electrode 21, but when the electric field is not applied, the alignment state is specified by the alignment layer 16 and the alignment layer 22.

Further, in the liquid crystal device, a polarizing film, a retardation film, a polarizing plate or the like may be arranged on the side of the counter substrate 20 on which light is incident and on the side of the TFT array substrate 10 from which transmission light exits, respectively, according to the operation mode, such as a twisted nematic (TN) mode, a super twisted nematic (STN) mode, a vertically aligned (VA) mode, and a polymer dispersed liquid crystal (PDLC) mode, or according to a normally white mode/normally black mode, respectively. Further, on the TFT array substrate 10, there may be provided a sampling circuit that samples an image signal on the image signal line to supply it to the data lines, a precharge signal that supplies a predetermined voltage level of precharge signal to a plurality of data lines, and a check circuit that checks the quality and defects of the liquid crystal device during manufacturing or before shipping, in addition to the data line driving circuit 101 and the scanning line driving circuit 104.

1-2: Configuration of main unit of liquid crystal device

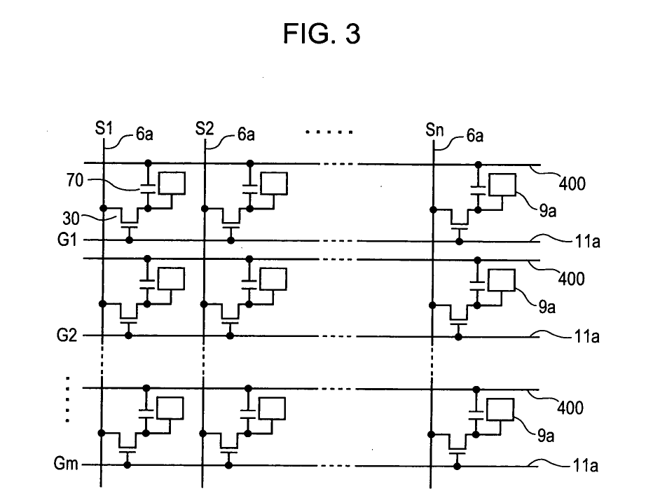

The configuration of a main unit of a liquid crystal device according to the present embodiment will now be described with reference to FIGS. 3 to 6.

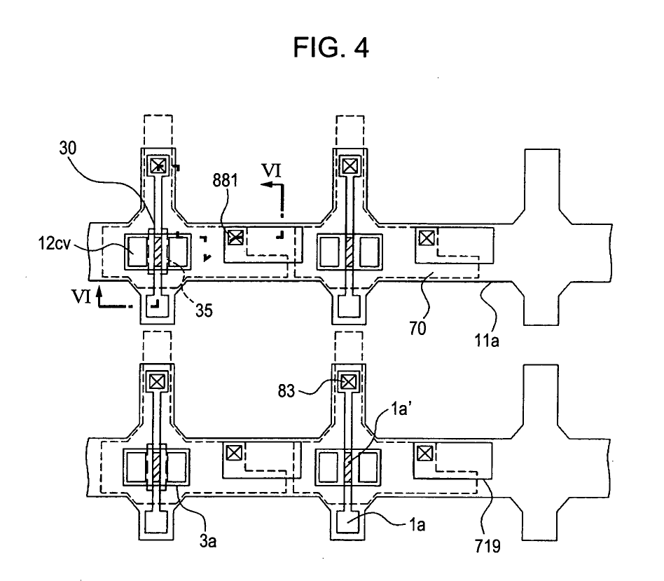

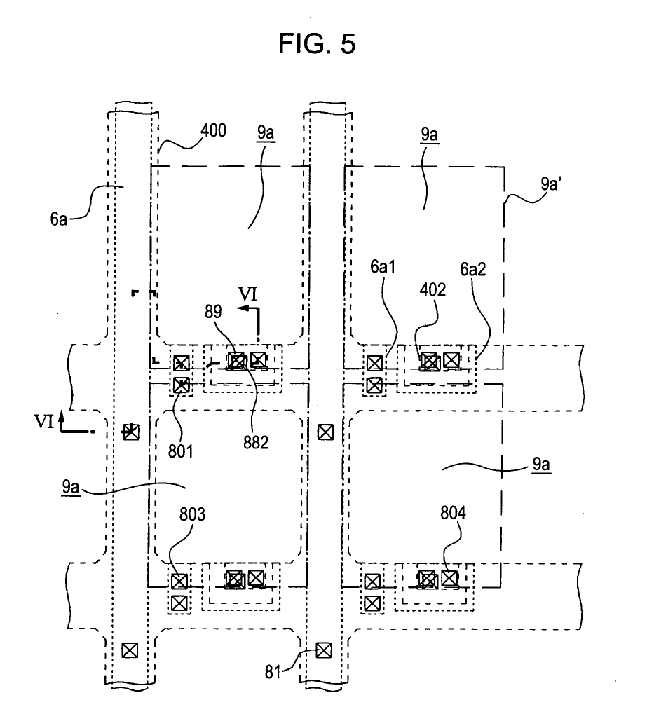

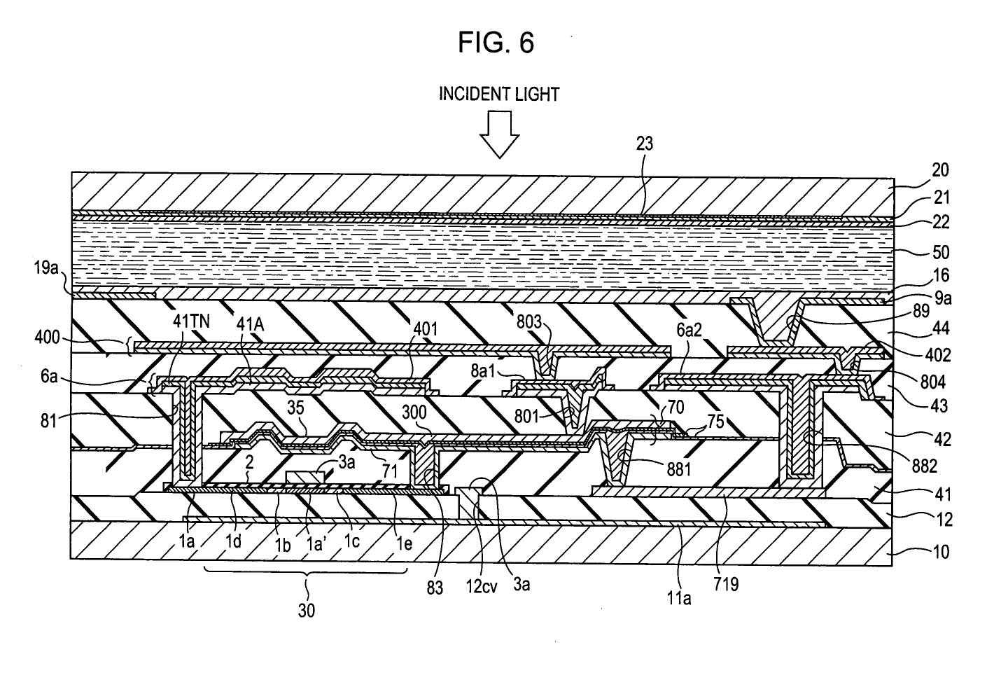

FIG. 3 is an equivalent circuit diagram showing a pixel unit of the liquid crystal device according to the embodiment. FIGS. 4 and 5 are plan views showing a partial configuration of the pixel unit on the TFT array substrate, respectively. Further, FIGS. 4 and 5 correspond to a lower layer portion (FIG. 4) and an upper layer portion of the stacked structure to be described below, respectively. FIG. 6 is a cross-sectional view taken along the line II-II′ when FIGS. 4 and 5 are overlapped. In FIG. 6, the scale of each layer or member is adjusted in order to have a recognizable size in the drawings.

1-2-1: Principle Configuration of Pixel Unit

As shown in FIG. 3, in the image display region 10a, a plurality of scanning lines 11a and a plurality of data lines 6a are arranged crossing each other, and a pixel unit selected by one of the scanning lines 11a and one of the data lines 6a is arranged between the lines. Each pixel unit includes a TFT 30, a pixel electrode 9a, and a storage capacitor 70. The TFT 30 is provided to apply each of image signals S1, S2, . . . , Sn supplied from the data lines 6a to a selected pixel, and has a gate connected to the scanning line 11a, a source connected to the data line 6, and a drain connected to the pixel electrode 9a. A liquid crystal capacitor is formed between the pixel electrode 9a and the counter electrode 21 to be described below, holding the input image signals S1, S2, . . . , Sn for a predetermined period. One electrode of the storage capacitor 70 is connected to the drain of the TFT 30 parallel to the pixel electrode 9a, and the other electrode is connected to a wiring line 400 having a fixed potential to have a fixed potential.

The liquid crystal device employs, for example, a TFT active matrix driving scheme, such that scanning signals G1, G2, . . . , Gm are sequentially applied from the scanning line driving circuit 104 (see FIG. 1) to each scanning line 11a, and accordingly, for columns of the selection pixel unit in a horizontal direction where the TFTs 30 turn on, the image signals S1, S2, . . . , Sn are applied from the data line driving circuit 101 (see FIG. 1) to the data line 6a. Thereby, each of the image signals are supplied to the pixel electrode 9a corresponding to the selection pixel. In other words, a display region for each pixel (hereinafter, referred to as a pixel region) is delimited by the pixel electrode 9a. The TFT array substrate 10 is arranged to face the counter substrate with the liquid crystal layer 50 therebetween (see FIG. 2), so that the electric field is applied to the liquid crystal layer 50 for each pixel unit partitioned as describe above to control the amount of transmission light between both substrates for each pixel and to display the gray-scale image. At this time, the image signal retained in each pixel unit is prevented from leaking by means of the storage capacitor 70.

As such, since the active matrix scheme keeps image quality by retaining charge for each pixel unit, it is necessary to suppress leakage of the charge (i.e., leakage current) for the pixel unit as low as possible. However, if the TFT 30 is formed using a typical polysilicon TFT, there is a possibility (although it is small) that the leakage current caused by light absorption will be generated. According to the present embodiment, the TFT 30 is illustrated as one specific example of the ‘thin film transistor’ of the invention.

1-2-2: Specific Configuration of Pixel Unit

A specific configuration of the pixel unit that implements the above-mentioned operations will now be described with reference to FIGS. 4 to 6.

Referring to FIGS. 4 to 6, each circuit element of the above-mentioned pixel unit is provided on the TFT array substrate 10 as a patterned and stacked conductive layer. The TFT array substrate 10 of the present embodiment is made of a quartz substrate and faces the counter substrate 20, which is made of a glass substrate or a quartz substrate. In addition, from the lower layer, there are provided a first layer including the scanning line 11a, a second layer including the gate line 3a, a third layer including a fixed-potential capacitor electrode of the storage capacitor 70, a fourth layer including the data line 6a, a fifth layer including the capacitor wiring line 400, and a sixth layer including the pixel electrode 9a. In addition, a base insulating layer 12 is interposed between the first and second layers, a first interlayer insulating layer 41 between the second and third layers, a second interlayer insulating layer 42 between the third and fourth layers, a third interlayer insulating layer 43 between the fourth and fifth layers, and a fourth interlayer insulating layers between the fifth and sixth layers, respectively, to prevent the above elements from being short-circuited. Also, of those mentioned, the first to third layers are shown in FIG. 4 as a lower layer part and the fourth to sixth layers are shown in FIG. 5 as an upper layer part. Configuration of first layer including scanning lines

The first layer includes the scanning lines 11a. The scanning lines 11a are each patterned to have a shape including a main line portion that extends along the X direction of FIG. 4 and a protrusion portion that extends along the Y direction of FIG. 4 in which the data line 6a or the capacitor wiring line 400 extends. The scanning line 11a may be made of, for example, a conductive polysilicon, or may be made of an elemental metal including at least one high melting point metal, such as Ti, Cr, W, Ta, and Mo, an alloy, a metal silicide, poly silicide or a stacked structure thereof. The scanning lines 11a of the present embodiment, which covers a region between the pixel regions, if possible, can also act as a light shielding layer that shields the TFT 30 from the bottom. Further, the region around the pixel region is specified as a light shielding region by the light shielding layer arranged between the TFT array substrate 10 and the counter substrate 20. In the light shielding region, only the rectilinear propagation component out of the incident light (see FIG. 6) on the liquid crystal device is shielded.

Configuration of Second Layer Including TFT

The second layer includes the TFT 30 and a relay electrode 719. The TFT 30, which is one example of the ‘thin film transistor’ of the invention, has, for example, an LDD structure, and includes a gate electrode 3a, a semiconductor layer 1a, and a gate insulating layer 2 that isolates the gate electrode 3a from the semiconductor layer 1a. The gate insulating layer 2 is made of a thermally oxidized silicon oxide layer such as, for example, a high temperature oxide (HTO). The gate electrode 3a is made of, for example, conductive polysilicon. The silicon layer 1a is made of, for example, polysilicon, and includes a channel region 1a′, a lightly doped source region 1b, a lightly doped drain region 1c, a highly doped source region 1d, and a highly doped drain region 1e.

In the TFT 30, a leakage current is generated through light excitation when light is irradiated onto, in particular, the channel region 1a′. Here, according to the present embodiment, a concave portion 35 is formed on the surface of the first interlayer insulating layer 41 (see FIG. 6), in order to effectively shield the channel region 1a′ of the TFT 30. The concave portion 35 is selectively provided in a region corresponding to respective channel regions 1a′ through etching, for example. More specifically, the concave portion 35 is provided in a region where the channel regions 1a′ can be shielded.

Further, it is preferable that the TFT 30 have an LDD structure: however, it may have an offset structure where impurity implantation is not performed in the lightly doped source region 1b and the light doped drain region 1c, or it may have a self-aligned structure where highly concentrated impurities are implanted using the gate electrode 3a as a mask to form the highly doped source region and the highly doped drain region. In addition, the relay electrode 719 is the same layer as the gate electrode 3a, for example.

The gate electrode 3a of the TFT 30 is electrically connected to the scanning line 11a through the contact hole 12cv formed in the base insulating layer 12. The base insulating layer 12 is made of, for example, a silicon oxide layer such as HTO, or a non silicate glass (NSG) layer, which isolates the first and second layers. In addition, since the base insulating layer is formed over the entire TFT array substrate 10, it serves to prevent a change of element characteristic of the TFT 30 caused by roughness or contamination due to polishing of the substrate surface.

Configuration of Third Layer including Storage Capacitor

The third layer includes the storage capacitor 70. The storage capacitor 70 is configured such that a dielectric layer 75 is interposed between a capacitor electrode 300 and a lower electrode 71. Here, the capacitor electrode 300 is electrically connected to the capacitor wiring line 400. The lower electrode 71 is electrically connected to the highly doped drain region 1e of the TFT 30 and the pixel region 9a, respectively.

The lower electrode 71 and the highly doped drain region 1e are connected through a contact hole 83 which is formed in the first interlayer insulating layer 41. In addition, the lower electrode 71 and the pixel electrode 9a relay respective layers using contact holes 881, 882, and 804, a relay electrode 719, a second relay electrode 6a2, and a third relay electrode 402, thereby being electrically connected to a contact hole 89.

The capacitor electrode 300 may be made of, for example, an elemental metal including at least one high melting point metal, such as Ti, Cr, W, Ta, and Mo, an alloy, a metal silicide, poly silicide or a stacked structure thereof, or is preferably made of tungsten silicide. Accordingly, the capacitor electrode serves to shield light incident on the TFT 30 from the upper side. In addition, the lower electrode 71 uses, for example, a conductive polysilicon. The dielectric layer 75 is made of a silicon oxide layer, such as an HTO layer, a low temperature oxide (LTO) layer, or a silicon nitride layer, having a relatively low thickness of about 5 to 200 nm.

In addition, the first interlayer insulating layer 41 is made of, for example, NSG. Alternatively, the first interlayer insulating layer may use silicate glass such as phosphorus silicate glass (PSG), boron silicate glass (BSG), and (boron-phosphorus silicate glass), a silicon oxide or a silicon nitride.

Further, the storage capacitor 70 is formed in the light shielding region, as shown in FIG. 4, to shield the TFT 30 from the surface side, thus serving as an example of the ‘light shielding layer’ of the invention. Here, a part of the storage capacitor 70 is formed directly on the concave portion 35.

Configuration of Fourth Layer Including Data Lines

The fourth layer includes the data line 6a. The data line 6a is formed as a three-layered film having an Al layer 41A, a titanium nitride layer 41TN, and a silicon nitride layer 401 from the bottom. The silicon nitride layer 401 is patterned to have a size large enough to cover the Al layer 41A and the titanium nitride layer 41TN of the lower layer. In addition, the fourth layer is the same layer as the data line 6a, in which the capacitor wiring relay layer 6a1 and the second relay electrode 6a2 are formed. Each of them is separated, as shown in FIG. 5.

Here, the data line 6a is electrically connected to the highly doped source region 1d of the TFT 30 through a contact hole that penetrates the first interlayer insulating layer 41 and the second interlayer insulating layer 42.

In addition, the capacitor wiring relay layer 6a1 is electrically connected to the capacitor electrode 300 through the contact hole 801 which is formed in the second interlayer insulating layer 42, and relays between the capacitor electrode 300 and the capacitor wiring line 400. The second relay electrode 6a2 is electrically connected to the relay electrode 719 through the contact hole 882 that penetrates the first interlayer insulating layer 41 and the second interlayer insulating layer 42, as described above. The second interlayer insulating layer 42 is made of, for example, NSG, or alternatively, it may be made of silicate glass such as PSG, BSG, and BPSG, silicon nitride and silicon oxide.

Configuration of Fifth Layer including Capacitor Wiring Lines

The fifth layer includes the capacitor wiring line 400 and the third relay electrode 402. The capacitor wiring line 400 extends up to the periphery of the image display region 10a and is electrically connected to a constant potential source, which is at a fixed potential. In addition, the capacitor wiring line 400 is electrically connected to the capacitor wiring relay layer 6a1 through the contact hole 803 which is formed in the third interlayer insulating layer 43. The capacitor wiring line 400 is a two-layered structure with, for example, Al and titanium nitride stacked.

The capacitor wiring line 400 is formed in a lattice shape that extends in the X and Y directions, as shown in FIG. 5, and a notch to form a region for the third relay electrode 402 is provided in a region extending in the X direction. The capacitor wiring line 400 also acts as a light shielding layer, so that it is formed wider than those circuit elements such as the data line 6a, the data line 11a, and the TFT 30 of the lower layer to cover them. Thus, the capacitor wiring line 400 has a shape that ultimately specifies the light shielding region.

In addition, the fifth layer is the same layer as the capacitor wiring line 400, in which the third relay electrode 402 is formed. The third relay electrode 402 relays between the second relay electrode 6a2 and the pixel electrode 9a through the contact hole 804 and the contact hole 89, as described above.

The third interlayer insulating layer 43 is formed below the entire surface of the fifth layer. The third interlayer insulating layer 43 may be made of, for example, silicate glass such as NSG, PSG, BSG, and BPSG, silicon nitride or silicon oxide.

Configuration of Sixth Layer Including Pixel Electrodes

The fourth interlayer insulating layer 44 is formed over the entire fifth layer, and the pixel electrodes are formed on the fifth layer as a sixth layer. The fourth interlayer insulating layer 44 has a contact hole 89 which is formed to electrically connect between the pixel electrode 9a and the third relay electrode 402. The fourth interlayer insulating layer 44 may be made of, for example, silicate glass such as NSG, PSG, BSG, and BPSG, silicon nitride or silicon oxide.

The pixel electrodes 9a (shown in a dotted line 9a′ in FIG. 5) are arranged in respective pixel regions partitioned in rows and columns. The formation region of the pixel electrode 9a approximately corresponds to the pixel region, so that the data line 6a and the scanning line 11a are arranged in a lattice shape in the light shielding region (see FIGS. 4 and 5). The pixel electrode 9a is made of a transparent conductive layer such as, for example, indium tin oxide (ITO). Further, the alignment layer 16 is formed on the pixel electrode 9a. Heretofore, a configuration of the pixel unit at the side of the TFT array substrate 10 has been described.

On the other hand, for the counter substrate 20, the counter electrodes 21 are provided over the entire counter surface, and the alignment layer 22 is provided on the counter electrodes 21 (at a lower side of the counter electrode in FIG. 6). The counter electrode 21 is made of a transparent conductive layer such as an ITO layer, similar to the pixel electrode 9a. Further, the light shielding layer 23 is provided to cover a region facing at least the TFT 30, in order to prevent an optical leakage current from being generated in the TFT 30.

The liquid crystal layer 50 is provided between the TFT array substrate 10 and the counter substrate 20 configured as described above. Liquid crystals are injected into a space where the peripheral portion of the substrates 10 and 20 is sealed with a sealant, forming the liquid crystal layer 50. When an electric field is not applied between the pixel electrodes 9a and the counter electrodes 21, the liquid crystal layer 50 is made to have a predetermined alignment state by the alignment layer 16 and the alignment layer 22, for which alignment processing such as a rubbing processing is performed.

1-3: Configuration Related to Light Shielding of TFT

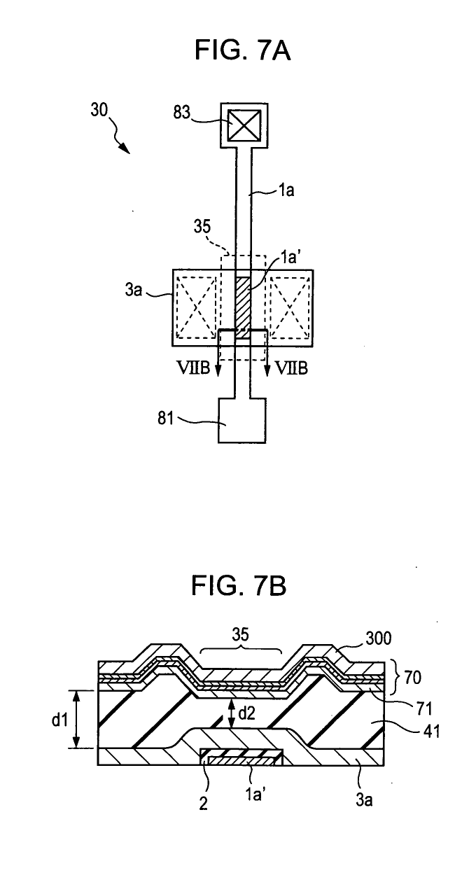

The configuration of an upper portion to shield the TFT 30 will now be described in detail with reference to FIGS. 7A and 7B. FIG. 7A is a plan view of the TFT 30, and FIG. 7B is a cross-sectional view taken along the line III-III′ line of FIG. 7A.

Referring to FIG. 7, the concave portion 35 is formed on a surface of the interlayer insulating layer 41 according to the present embodiment, and a part of the storage capacitor 70 extends directly on the concave portion 35. The storage capacitor 70 has a light shielding function and is formed as a layer adjacent to the TFT 30, so that the storage capacitor 70 can shield the channel region 1a′ so long as they are very close to each other. However, a thickness d1 of the interlayer insulating layer 41 that separates the storage capacitor 70 from the channel region 1a′ is about 600 nm to 800 nm (i.e., 6000 Å to 8000 Å), and thus, there is a chance that light will be incident from a gap formed therein. Therefore, it is necessary to make the light shielding region closer to the channel region 1a′ in order to effectively shield the channel region 1a′ from multiple reflection inside the liquid crystal device.

Here, in the present embodiment, the concave portion 35 is selectively formed in a region where the channel region 1a′ out of the surface of the interlayer insulating layer 41 can be light shielded. In other words, in a region where the concave region 35 is formed, the thickness d2 of the interlayer insulating layer 41 is reduced in accordance with a depth of the concave portion 35. For example, when the thickness d1 of the interlayer insulating layer 41 is approximately 600 nm to 800 nm, the thickness d2 is locally determined to be about 400 nm only for the formation region of the concave portion 35. Consequently, the storage capacitor 70 serving as a light shielding layer can be positioned closer to the channel region 1a′ by a distance equal to the amount of thinning of the interlayer insulating layer 41, thus improving the light shielding effect.

In addition, the interlayer insulating layer 41 herein is arranged directly on the TFT 30, and the storage capacitor 70 is formed directly on the interlayer insulating layer 41. Thus, there exists only one layer of the interlayer insulating layer 41 between the channel region 1a′ and the storage capacitor 70, which is a light shielding layer, and accordingly, it is possible to make the light shielding layer as close as possible to the channel region 1a′. Therefore, a high light shielding effect can be achieved.

In forming the storage capacitor 70 to be close to the channel region 1a′ as described above, the concave portion 35 may be selectively formed only in a region corresponding to the channel region on the interlayer insulating layer 41. The formation region of the concave portion 35 can be further enlarged, but when the concave portion 35 is formed large enough not to be called ‘local’, a sufficient light shielding effect can be expected. On the other hand, when the overall interlayer insulating layer 41 is formed to be thin, there is a chance that an adverse effect caused by a step due to the concave portion 35, an electrical effect between the storage capacitor 70 and the TFT 30, and cracking will occur. In reality, the size or shape of the formation region of the concave portion 35 and the depth of the concave portion 35 are appropriately designed with this in mind. In other words, the region herein corresponding to the channel region 1a′ of the interlayer insulating layer 41 is selectively formed to be thin, but the entire interlayer insulating layer 41 is not formed to be thin, so that the above problems can be avoided.

Further, in order to prevent these problems and to prevent the concave portion 35 from making the gate electrode 3a and the lower electrode 71 short-circuited through the interlayer insulating layer 41, it is desirable that the depth of the concave portion 35 be precisely formed through etching, for example.

In the liquid crystal device, light is incident from the upper layer of the TFT array substrate 1 to the pixel region (see FIG. 6), but the incident light diffusely reflects in the wiring lines made of an Al-based material like the data line 6a, so that it may be irradiated onto the TFT 30 arranged on the light shielding region. Correspondingly, the storage capacitor, which is an example of the light shielding layer, is provided on a surface of the concave portion 35, so that it can be located close to the channel region 1a′ to shield light.

1-4: Method of Manufacturing Liquid Crystal Device

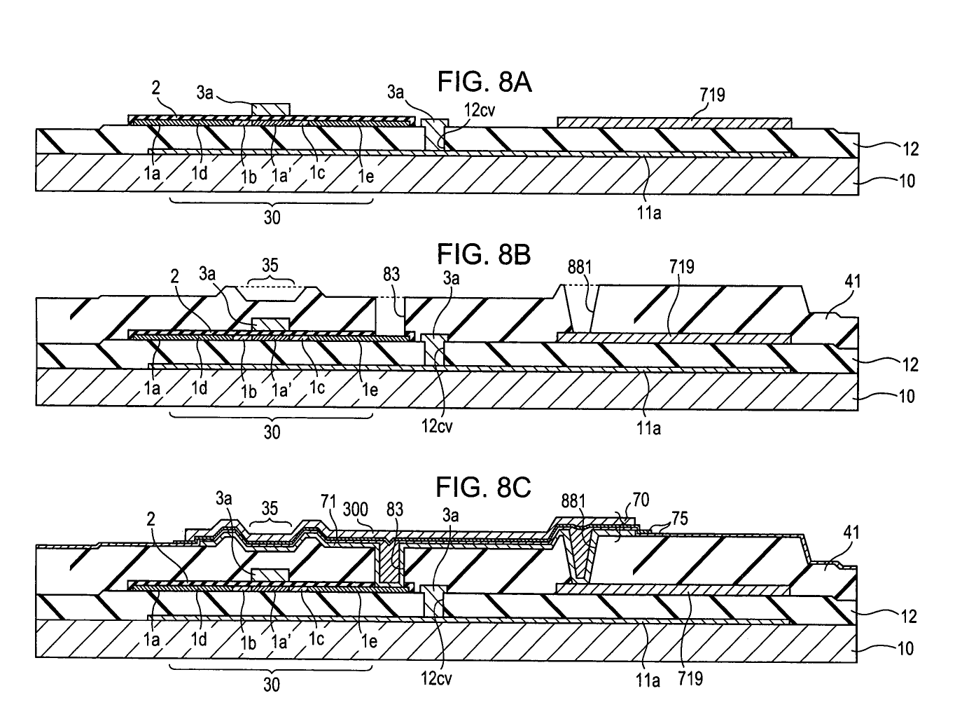

A method of manufacturing the liquid crystal device, mainly with respect to essential parts thereof, will be described with reference to FIG. 8. Here, FIGS. 8A to 8C show a process of manufacturing the liquid crystal device in sequence according to the present embodiment.

First, in the process shown in FIG. 8A, scanning lines 11a and base insulating layer 12 are formed on a TFT array substrate 1, and relay electrodes 719 and TFTs 30 serving as a second layer are formed thereon. In other words, a semiconductor layer 1a and a gate insulating layer 2 are formed. In addition, contact holes 12cv are formed to penetrate the base insulating layer 12, and then, gate electrodes 3a and the relay electrodes 719 are made of the same layer, and patterned to have respective predetermined shapes through etching.

Next, in the process shown in FIG. 8B, an interlayer insulating layer 41 is formed on one side of the surface. Subsequently, a predetermined shape of a concave portion 35 is formed on the surface of the interlayer insulating layer 41 through etching. For example, a mask having an opening corresponding to a planar shape of the concave portion 35 is arranged on the interlayer insulating layer 41, and a wet etching is performed therefrom. At this time, by setting the etching rate, the concave portion 35 is tapered as shown in FIG. 8B. In addition, through the etching, the concave portion 35 can be precisely formed as shown in FIG. 6, and thus the concave portion 35 can be locally formed on the surface of the interlayer insulating layer 41. After this processing, contact holes 83 and 881 are also formed.

Next, in the processing shown in FIG. 8C, a storage capacitor 70 is formed using the interlayer insulating layer as a base. The storage capacitor 70 is formed such that a part thereof is fitted into the concave portion 35. The subsequent processing is routinely performed, and a stacked structure is preferably formed in sequence.

In the present embodiment described above, the storage capacitor 70 shields light from the surface of the channel region 1a′ and the periphery thereof through a part of the interlayer insulating layer 41 that becomes thinner in accordance with the depth of the concave portion 35, so that light incident on the channel region 1a′ can be reliably suppressed, thus efficiently suppressing an optical leakage current. Therefore, with the liquid crystal device, a high quality image can be displayed without nonuniform image quality, decrease of the contrast ratio, and flickering.

Further, the concave portion 35 is partially formed on the interlayer insulating layer 41, so that there is little structural problem other than the optical leakage current. Also, since the entire interlayer insulating layer 41 is not formed to be thin, various problems caused by a thin interlayer insulating layer 41 can be avoided. Further, the concave portion 35 is simply formed through etching, so that there is little or no problem in terms of the process and production efficiency.

2: Modified Examples Regarding Shape of Concave Portion

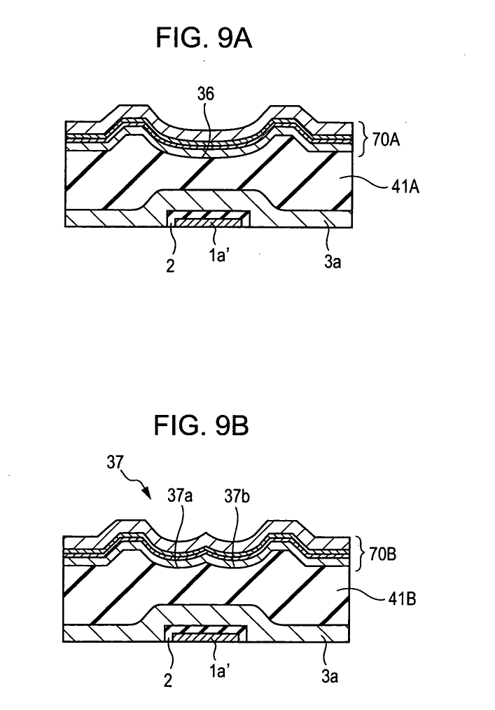

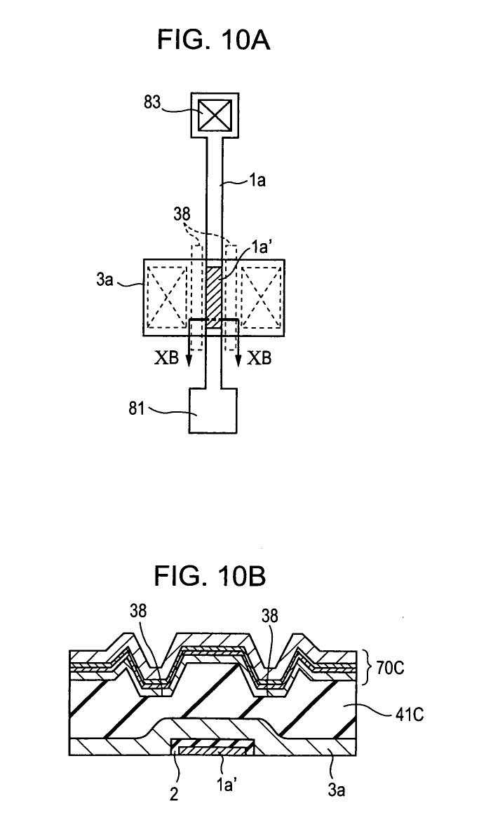

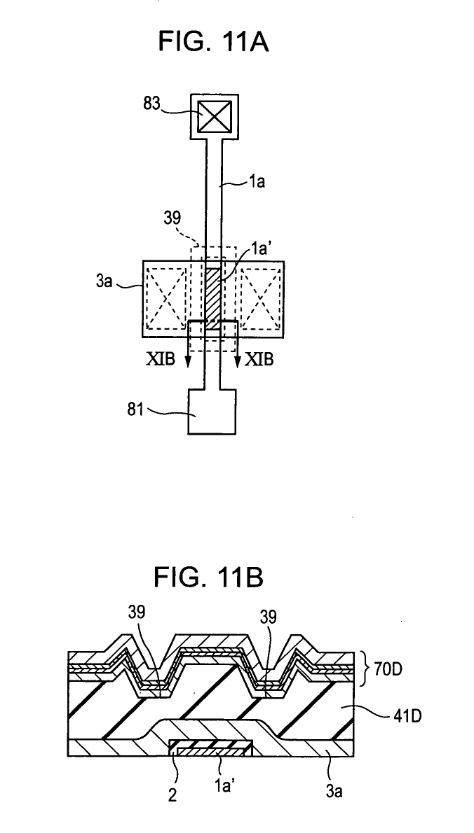

A modified example regarding the shape of the concave portion in the liquid crystal device of the first embodiment will now be described with reference to FIGS. 9 to 11. FIGS. 9 to 11 show configurations of portions regarding modified examples of the liquid crystal device. Here, for cross-sectional views regarding the modified example, any configuration in FIGS. 9 to 11 corresponds to FIG. 7B in the first embodiment. Further, FIGS. 10A and 11A correspond FIG. 7A.

In each modified embodiment shown in FIGS. 9A and 9B, concave portions 36 and 37 are formed instead of the concave portion 35. The concave portions 36 and 37 have a semi-circle-shaped cross section, and are formed on the interlayer insulating layers 41A and 41B in a groove shape. These can be formed, for example, using an etchant having a different etching ratio from that used for wet etching of the concave portion 35. In this way, a rounded cross section contributes to forming the storage capacitors 70A and 70B in the concave portions 36 and 37 with the uniform thickness.

In addition, the concave portion 37 has the concave portion 37a and the concave portion 37b parallel to each other, each of whose width is narrower than the formation region such that the cross section has a ripple shape. This can be formed, for example, through a two-step etching using a mask that has openings corresponding to the concave portions 37a and 37b, respectively. In the concave portion 37, the surface area of the storage capacitor formed thereon can be increased. Therefore, a storage capacitor having a large capacitance with respect to the area of the formation region can be provided, which leads to high precision. Further, when each of the concave portions 37a and 37b is designed as deep as possible around the periphery of the channel region 1a′, light can be effectively shielded.

Referring to FIGS. 10A and 10B, the concave portion 38 is formed in a groove shape along a region corresponding to the periphery of the channel region 1a′ of the interlayer insulating layer 41C. In this case, the storage capacitor 70C serving as a light shielding layer is configured to focus the light shielding on the periphery of the channel region 1a′, using a portion formed in the concave portion 38. Considering that the optical leakage current is generated from light infiltrating from the periphery of the channel region 1a′, it is important to light shield the edge of the channel region 1a′ in particular. Therefore, even when the concave portion is provided only in a region where light should be shielded, effective light shielding can be sufficiently obtained.

Referring to FIGS. 11A and 11B, the concave portion 39 is formed in a groove to surround a region corresponding to the periphery of the channel region 1a′ of the interlayer insulating layer 41D. According to the present embodiment, the gate electrode 3a, which covers the channel region 1a′, is exposed to the lower layer side through the contact hole 12cv, so that there is no barrier around the channel region 1a in the interlayer insulating layer 41D. Therefore, the concave portion 39 fully surrounds the edge of the channel region 1a′ so that effective light shielding can be realized.

3: Modified Examples of Stacked Structure

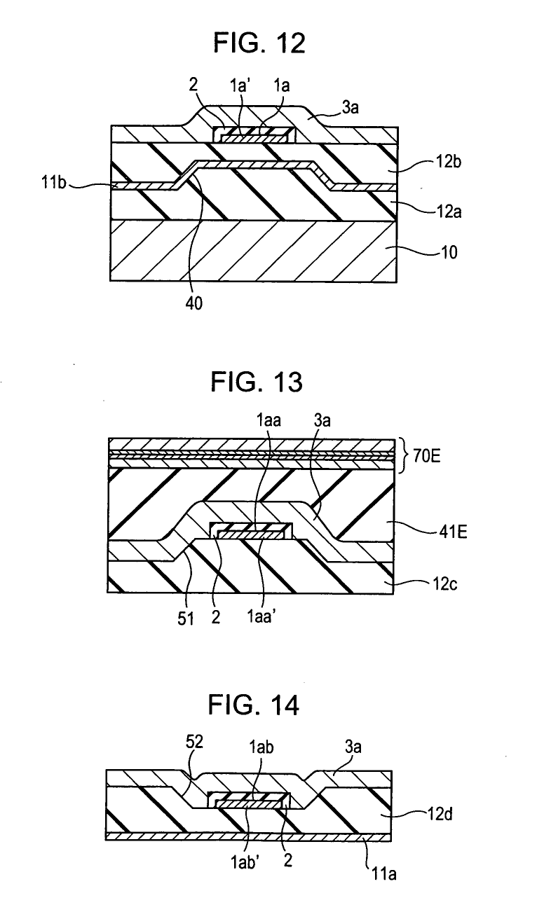

Modified examples of a stacked structure of the liquid crystal device of the first embodiment will now be described with reference to FIGS. 12 to 14. FIGS. 12 to 14 show configurations of modified examples regarding portions of the liquid crystal device. Further, cross-sectional views regarding the modified examples correspond to FIG. 7B in the first embodiment.

In the first embodiment, in order to light shield the channel region 1a′ from the upper layer side, a concave portion 35 pitted toward the semiconductor layer 1a is formed in the interlayer insulating layer 41 on the semiconductor layer 1a. Correspondingly, light reflected from the lower layer side may be irradiated onto the channel region 1a′.

In the modified example shown in FIG. 12, in order to light shield the channel region 1a′ from the lower layer side, a concave portion 40 pitted toward the semiconductor layer 1a (i.e., upward from the bottom surface) is formed in the base insulating layer 12b below the semiconductor layer. The concave portion 40 is locally formed in a region corresponding to the channel region 1a′, in the bottom surface of the base insulating layer 12b, and the thickness of the base insulating layer 12b is locally reduced in the formation region of the concave portion 40. For example, the actual concave portion 40 is formed as a result that the base insulating layer 12b covers a protrusion portion formed on the base insulating layer 12a, which is a base of the scanning line 11a. The surface of the base insulating layer 12b is planarized by, for example, performing a CMP processing or flowing SOG.

With the above configuration, the scanning lines 11a that also act as a light shielding layer can be positioned closer to the channel region 1a′ by a distance equal to the amount of thinning of the base insulating layer 12, so that the light shielding effect on the reflection light can be enhanced. In addition, according to the present modified example, the base insulating layer 12b is arranged immediately below the TFT 30, and the scanning line 11a, which is a light shielding layer, is provided immediately below the base insulating layer 12b. For this reason, since there is only one layer, that is, the base insulating layer 12b, between the scanning line 11a, which is a light shielding layer, and the channel region 1a′, the light shielding layer can be provided as close as possible to the channel region 1a′, thereby obtaining a high light shielding effect.

In the modified example shown in FIG. 13, on a surface of an interlayer insulating layer 41E facing a semiconductor layer 1aa, a concave portion 51 locally pitted toward a storage capacitor 70E (upward from the bottom surface), which is a light shielding layer, is formed in at least a part of a region facing the channel region 1aa′. In other words, according to the first embodiment, in forming the storage capacitor 70, which is a light shielding layer, in the concave portion 35, the semiconductor layer 1aa is formed in the concave portion 51. For example, the actual concave portion 40 is formed as a result that the interlayer insulating layer 41E covers a protrusion portion formed on the base insulating layer 12c, which is a base of the semiconductor layer 1aa. The surface of the interlayer insulating layer 41E is planarized by, for example, performing a CMP processing or flowing SOG.

Even in this case, the storage capacitor 70E serving as a light shielding layer can be positioned closer to the channel region 1aa by a distance equal to the amount of thinning of the interlayer insulating layer 41E due to the concave portion 51. Further, depending on the depth, the concave portion 51 can shield inclined light that attempts to infiltrate into the channel region 1aa′ from the lower layer surface.

In the modified example shown in FIG. 14, on a surface of a base insulating layer 12d facing a semiconductor layer lab, a concave portion 52 locally pitted toward the scanning line 11a serving as a light shielding layer is formed in at least a part of the region facing the channel region 1ab′. In other words, the present modified example adapts the configuration in which the upper layer side of the channel region 1aa′ is light shielded, as shown in FIG. 13, to a case where the lower layer side thereof is light shielded. Even in this case, the scanning line 11a serving as a light shielding layer can be positioned closer to the channel region lab by a distance equal to the amount of thinning of the base insulating layer 12d due to the concave portion 52. Further, depending on the depth, the concave portion 52 can shield inclined light that attempts to infiltrate into the channel region 1ab from the upper layer surface.

While stacked structures for a case where the light shielding layer is provided on the upper layer side of the TFT 30 and a case where the light shielding layer is provided on the lower layer side of the TFT 30 have been specifically described, the light shielding layer facing the channel region may be provided in both the upper and lower layers of the TFT 30, with the concave portion therebetween by combining the above cases. In addition, the shape of the concave portion for each modified example with respect to the stacked structure is not limited to the examples shown herein, but a variety of modifications can be made. For example, the above-mentioned shape can also be used as a modified example regarding the shape of the concave portion.

4: Second Embodiment

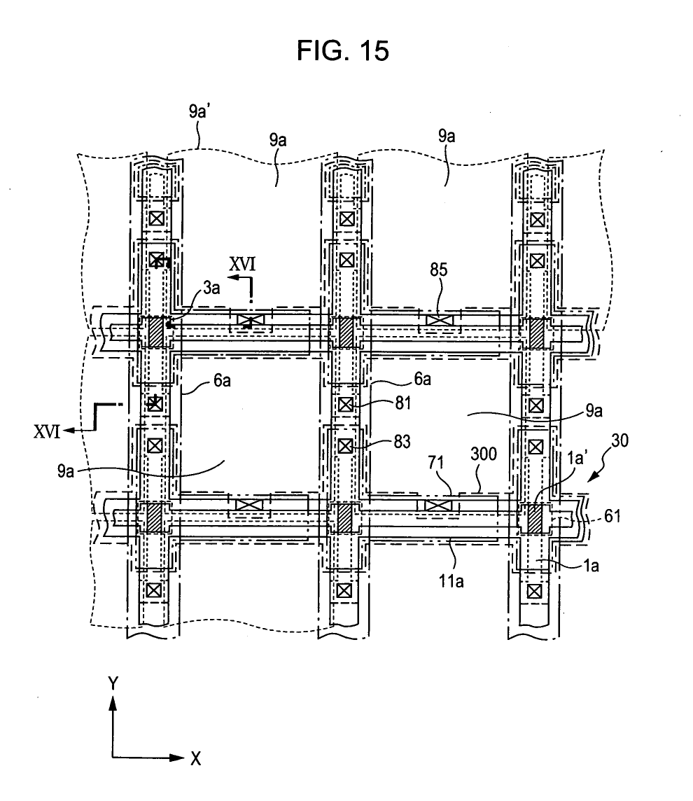

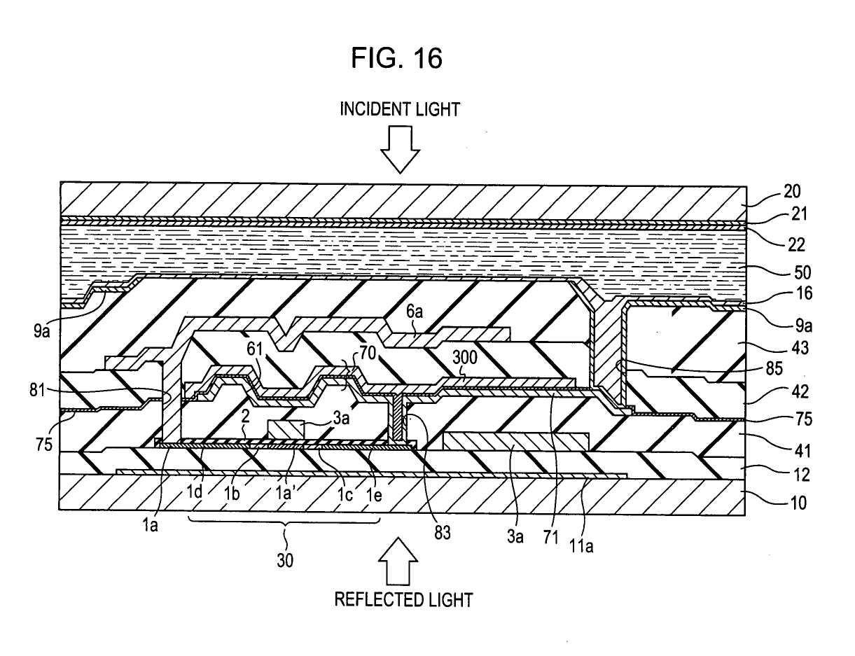

An electro-optical device according to a second embodiment of the invention will now be described with reference to FIGS. 15 and 16.

FIG. 15 is a partial plan view showing a configuration of a liquid crystal device according to a second embodiment of the invention, and FIG. 16 is a cross-sectional view taken along the line VI-VI of FIG. 15. FIGS. 15 and 16 correspond FIGS. 4 and 6, respectively. Further, in the following description, like numbers refer to like elements in the first embodiment and the description thereof is accordingly omitted.

Referring to FIGS. 15 and 16, in a liquid crystal device according to the present embodiment, the fourth interlayer insulating layer 44 and a capacitor wiring line 400 serving as the fifth layer are eliminated, and the pixel electrode 9a is connected only to the contact hole 85 with respect to the storage capacitor 70. Further, the gate electrode 3a has an electrode portion that covers the channel region 1a′ for each TFT 30 and a branch line portion connected to an array of the electrode portion in the X direction, the electrode portion and the branch line portion being formed integrally. In other words, by the branch line portion extending in the X direction, the gate electrode 3a also acts as a scanning line.

With the above configuration, a concave portion 61 is formed on a surface of the interlayer insulating layer 41. The concave portion 61 has a larger shape than the electrode portion to cover the electrode portion of the gate electrode 3a from above.

Advantages and effects of the present embodiment are the same as those in the first embodiment. In addition, the modifications related to the above-mentioned first embodiment can also be made in the present embodiment.

Further, in the above-mentioned embodiments and modified examples, while the TFT 30 made of a polysilicon TFT is used as an example of the ‘thin film transistor’ of the invention, a thin film transistor, in which problems occur through irradiation onto the channel region, may be used as the thin film transistor of the invention. For example, configurations other than those of the TFT 30 described above may be used, and other types of TFT such as an amorphous silicon TFT can be used.

5: Electronic Apparatus

The liquid crystal device described above is adapted to a projector, for example. Here, a projector that uses the liquid crystal device of the above embodiments as a light bulb will be described.

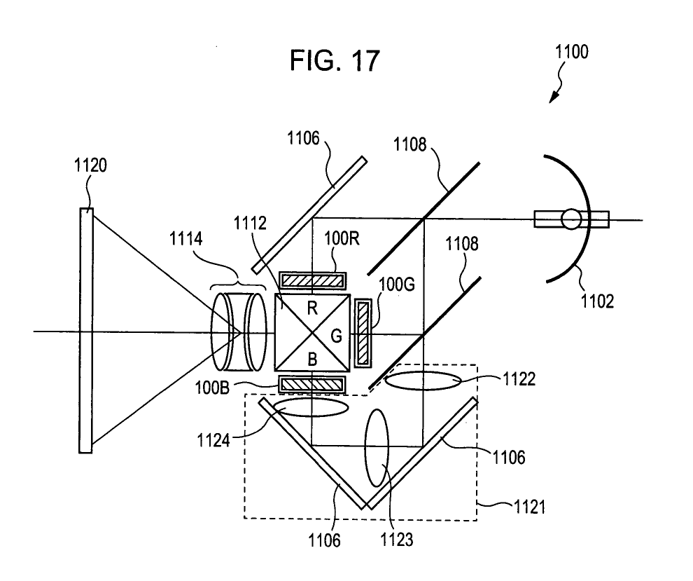

FIG. 17 is a plan view showing an example of a configuration of a projector. Referring to FIG. 17, a lamp unit 1102 including a white light source such as a halogen lamp is provided in a projector 1100. Light emitted from the lamp unit is separated into three primary colors of RGB by four mirrors 1106 and two dichroic mirrors 1108, and then is incident on liquid crystal devices 100R, 100B and 100G, serving as light valves, corresponding to the respective primary colors. The liquid crystal devices 100R, 100B and 100G have equivalent configurations as the above-mentioned liquid crystal, and in each configuration, primary color signals of R, G, and B supplied from an image signal processing circuit are modulated. Light modulated by the liquid crystal devices is incident on a dichroic prism 1112 from three directions. B light is directed through a relay lens system 1121 composed of an incident lens 1122, a relay lens 1123, and an exit lens 1124 to prevent optical loss caused by a long path. In the dichroic prism 1112, images having respective colors are synthesized and exit as a color image. The color image is projected onto a screen 1120 and so on, through a projection exit lens 1114.

Further, the liquid crystal device of the present embodiment can be adapted to a direct-view type or a reflection-type color display device, in addition to a projector. In this case, a RGB color filter as well as a protective layer may be formed in a region facing the pixel electrode 9a on the counter substrate 20. Alternatively, a color filter layer may be formed below the pixel electrode 9a facing the RGB on the TFT array substrate 10 using color resist. Further, in the above-mentioned cases, when a micro lens, corresponding to the pixel one to one, is provided on the counter substrate 20, the focusing efficiency of the incident light can increases and the display brightness can be improved. Furthermore, by depositing many interference layers having different refractive indices on the counter substrate 20, a dichroic filter which produces the RGB colors using interference of light may be formed. With the counter electrode attached with the dichroic filter, a brighter display can be performed.

As described above, while the invention has been described with respect to the liquid crystal device and the liquid crystal projector, it is preferable that the electro-optical device of the invention is a device which drives a display electrode using TFTs, and in addition to the liquid crystal device, it can be implemented as an electrophoresis device such as an electronic paper, and a display device using an electronic emission device (Field Emission Display and Surface-Conduction Electron-Emitter Display). In addition, the electronic apparatus of the invention is implemented by having an electro-optical device of the invention, and can be implemented as various electronic apparatuses such as a television receiver, a view finder type or monitor direct-view type video tape recorder, a car navigation device, a pager, an electronic notebook, a calculator, a word processor, a workstation, an image telephone, a POS terminal, and a device having a touch panel, in addition to the above-mentioned projector.

The invention is not limited to the above-mentioned embodiments, but a variety of modifications can be made without departing from the spirit and scope of the invention, which can be understood throughout the claims and description. Thus, an electro-optical device, an electronic apparatus having the electro-optical device, and a method of manufacturing the electro-optical device including the modifications thereof are also included in the invention.

1. An electro-optical device comprising:
a substrate;
a thin film transistor provided on the substrate and including a semiconductor layer having a channel region thereon;
a display electrode provided on the substrate and electrically connected to the thin film transistor;
a storage capacitor electrically connected to the display electrode;
an interlayer insulating layer deposited on at least one side of an upper layer side and a lower layer side of the semiconductor layer, the interlayer insulating layer having a surface that faces away from the semiconductor layer, the surfaces including a concave portion, the concave portion being locally pitted toward at least the edge of the channel region;
a light shielding layer deposited at the surface of the interlayer insulating layer facing away from the semiconductor layer, and the light shielding layer being formed at least in the concave portions and acting as a capacitor electrode of at least one side of each of the storage capacitors.

2. The electro-optical device according to claim 1,
wherein the interlayer insulating layer is provided directly on the thin film transistors on the substrate, and
wherein the light shielding layer is formed directly on the concave portions.

3. The electro-optical device according to claim 1,
wherein the interlayer insulating layer is provided directly below the thin film transistors on the substrate, and
wherein the light shielding layer is formed directly below the concave portions.

4. The electro-optical device according to claim 1,
wherein the concave portions are formed in a groove shape along a region corresponding to the edge of the channel region.

5. The electro-optical device according to claim 1,
wherein, for the concave portions, a plurality of concave portions is successively formed so that a cross section thereof has a ripple shape.

6. The electro-optical device according to claim 1,
wherein the concave portions are formed over the entire region corresponding to the channel region.

7. The electro-optical device according to claim 1,
wherein each of the storage capacitors includes a first electrode electrically connected to the display electrode and a second electrode arranged opposite to the first electrode and having a fixed potential, and
wherein the second electrode is arranged at a side closer to the semiconductor layer than the first electrode.

8. An electronic apparatus comprising the electro-optical device according to claim 1.

9. A method of manufacturing an electro-optical device, the electro-optical device including a substrate; a thin film transistor provided on the substrate and including a semiconductor layer having a channel region thereon; a display electrode provided on the substrate and electrically connected to the thin film transistor; a storage capacitor electrically connected to the display electrode; an interlayer insulating layer deposited on at least one side of an upper layer side and a lower layer side of the semiconductor layer, the interlayer insulating layer having a surface that faces away from the semiconductor layer, the surfaces including a concave portion, the concave portion being locally pitted toward at least the edge of the channel region; a light shielding layer deposited at the surface of the interlayer insulating layer facing away from the semiconductor layer, and the light shielding layer being formed at least in the concave portions and acting as a capacitor electrode of at least one side of each of the storage capacitors, the method comprising:
forming the semiconductor layer on the substrate;
forming the interlayer insulating layer, acting as a base of the light shielding layer, at one side on the substrate;
after forming the interlayer insulating layer, etching the interlayer insulating layer to form unevenness on a surface of the interlayer insulating layer in a region corresponding to the channel region so that the light shielding layer can be locally closer to the semiconductor layer;
after forming the unevenness, forming the light shielding layer in a region where the unevenness is formed, at least on the surface of the interlayer insulating layer; and
after forming the light shielding layer, forming a dielectric layer and a capacitor electrode, the light shielding layer acting as another a capacitor electrode of the storage capacitor.
